(19) United States
(12) Patent Application Publication
(10) Pub. No.: US 2007/0282946 A1
(43) Pub. Date: Dec. 6, 2007

(54) METHOD FOR PROVIDING A STRUCTURED E-MAIL QUERY

(76) Inventors: Indran Naick, Cedar Park, TX (US); Jeff K. Wilson, Austin, TX (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/421,138

(22) Filed: May 31, 2006

(51) Int. Cl. G06F 15/16

(52) U.S. Cl. 709/204

(57) ABSTRACT

The present invention is a method for providing a structured e-mail query. The method includes receiving an input of a destination e-mail address, the destination e-mail address being associated with a service provider. The method further includes activating a query formatter in response to receiving the input e-mail address, the query formatter configured for directing query construction. The method further includes receiving a query for a desired service of the service provider. The query is contained within an e-mail and is formatted for automated processing by an e-mail server associated with the destination e-mail address.

### FIELD OF THE INVENTION

The present invention relates to the field of electronic communications and particularly to a method for providing a structured e-mail query.

### BACKGROUND OF THE INVENTION

Currently, locating and utilizing online information and services may be a time-consuming endeavor. A first obstacle may be finding a website which provides the desired information and services. Once a website providing the desired information and services is found, another obstacle may be finding the exact location on the website from which the desired information and services may be accessed. Both of the above-referenced obstacles may result in a lot of time-wasting, online navigation by a party trying to locate and access such services and information.

Therefore, it may be desirable to have a method for providing a structured e-mail query which addresses the above-referenced problems and limitations of the current solutions.

### SUMMARY OF THE INVENTION

Accordingly, an embodiment of the present invention is directed to a method for providing a structured e-mail query. The method includes receiving an input of a destination e-mail address, the destination e-mail address being associated with a service provider. The method further includes activating a query formatter in response to receiving the input e-mail address, the query formatter configured for directing query construction. The method further includes receiving a query for a desired service of the service provider. The query is contained within an e-mail and is formatted for automated processing by an e-mail server associated with the destination e-mail address.

In a further embodiment, the present invention is directed to a method for providing a structured e-mail query. The method includes downloading a query formatter, the query formatter configured for directing query construction. The method further includes receiving an input of a destination e-mail address, the destination e-mail address being associated with a service provider. The method further includes activating the query formatter in response to receiving the input e-mail address. The method further includes receiving a query for a desired service of the service provider. The query is contained within an e-mail and is formatted for automated processing by an e-mail server associated with the destination e-mail address.

In an additional embodiment, the present invention is directed to a method for providing an e-mail from a service provider, the e-mail being responsive to a structured query. The method includes receiving an input of a user e-mail address. The method further includes activating a query formatter, the query formatter configured for directing query construction. The method further includes receiving a structured query for a desired service of the service provider. The method further includes transmitting an e-mail to the user e-mail address, the e-mail containing at least one Uniform Resource Locator (URL), the at least one URL corresponding to a webpage of the service provider from which the desired service is accessible.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow chart illustrating a method for providing a structured e-mail query in accordance with an exemplary embodiment of the present invention;

FIG. 2 is a flow chart illustrating a method for providing a structured e-mail query in accordance with an alternative exemplary embodiment of the present invention;

FIG. 3 is a flow chart illustrating a method for providing an e-mail from a service provider, the e-mail being responsive to a structured query in accordance with a further alternative exemplary embodiment of the present invention; and

FIG. 4 illustrates a sample query formatter prompt screen for implementation with exemplary embodiments of the present invention.

### DETAILED DESCRIPTION OF THE INVENTION

Reference will now be made in detail to the presently preferred embodiments of the invention, examples of which are illustrated in the accompanying drawings.

Since the advent of the Internet, an ever-increasing number of goods and services have become available for purchase and/or use online. Currently, the Internet allows users access to such services as online banking, stock online portfolio management, and the like. For example, a user is now able to access a service, such as an Employee Stock Purchase Program (ESPP), online. An online ESPP allows a user (i.e., an employee) to purchase stock in his company online at a discount from market value. Further, an online ESPP allows a user real-time access to his ESPP account information, rather than having to wait for his quarterly statements to arrive in the mail. Additionally, an online ESPP provides a user the opportunity to initiate online, real-time trading of company stock purchased through the program. However, in order to access such services, a user typically needs to access the ESPP provider's website. This may be problematic if the user forgets the address of the ESPP provider's website. Further, even if a user locates the ESPP provider's website, the user may have difficulty finding the exact webpage within the site which will provide him with access to the information/services he desires. Therefore, the present invention provides a method for allowing a user to provide a structured query, via e-mail, to a service provider (ex.—ESPP provider). The purpose of the query is to obtain information from the service provider for facilitating the user's access to desired online information and/or services provided by the service provider. The query is structured in such a manner that it may be processed by an automated system, said processing resulting in generation of an e-mail response from the service provider which provides information for facilitating the user's access to the desired online information/services.

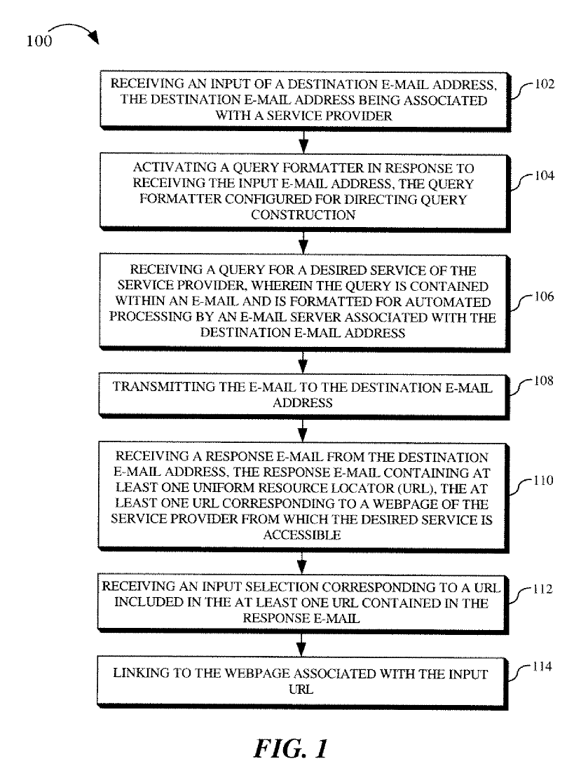

FIG. 1 is a flow chart illustrating a method for providing a structured e-mail query in accordance with an exemplary embodiment of the present invention. In the exemplary embodiment, the method 100 includes receiving an input of a destination e-mail address, the destination e-mail address being associated with a service provider 102. For example, a user of a computing device, such as a personal computer, a PDA, or the like, may be a subscriber to an online Employee Stock Purchase Program (ESPP) service. Further, the user may wish to utilize the computing device to access the online ESPP service to check on the current status of his stock portfolio. However, the user may have forgotten the website address of the online ESPP service provider. Alternatively, the user may know the website address of the service provider, but may have difficulty trying to find the exact webpage within the website that will allow him to access the information he seeks. Consequently, the user may choose to forego directly accessing the service provider's website and opt instead to communicate with the service provider by e-mail as an alternative method of locating/accessing desired services. In the exemplary embodiment, the destination e-mail address may be received by an e-mail program being utilized on the user's computing device. For example, the destination e-mail address (ex.—an e-mail address associated with the ESPP service provider), may be received by the e-mail program as a text entry or address book selection input made by the user, such as when the user is composing an e-mail to the service provider to request information about locating/accessing desired services.

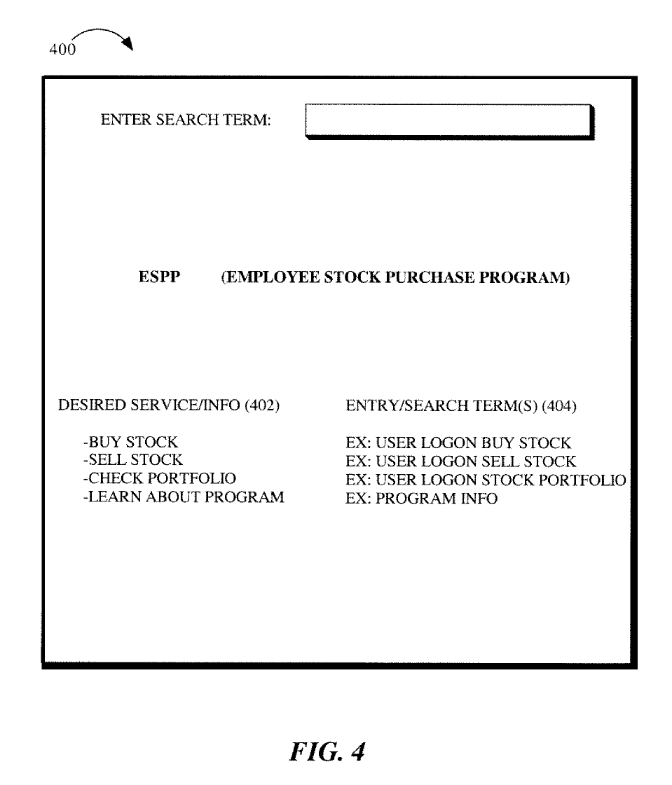

The method 100 further includes activating a query formatter in response to receiving the input e-mail address, the query formatter configured for directing query construction 104. In the exemplary embodiment, the query formatter may be a program, application, engine, or the like for directing query construction. For instance, the query formatter may be configured for directing construction of queries intended for a particular service provider. For example, the query formatter may be provided online via a website associated with the service provider (ex.—the ESPP service provider) and available for download. If the user is composing an e-mail to the service provider to obtain information about locating/accessing desired services, as discussed above, it is important that the e-mail include a structured query (i.e., a query which makes it clear exactly what service(s)/information the user is trying to locate). The query formatter, via prompts or the like, may provide information which directs the user in constructing a structured query for assisting the user in pinpointing desired services/information accessible via certain locations/webpages of the service provider's website. For instance, FIG. 4 illustrates a sample query formatter prompt screen 400 for implementation with the present invention. For example, the query formatter prompt screen 400 may display a list of possible desired service/information categories 402 and may further display a list of corresponding search terms 404, which a user may enter for providing a structured query which will result in generation of response information which will allow the user to access the desired info/services. In the exemplary embodiment, the e-mail program, in response to receiving the input e-mail address (ex.—the e-mail address of the ESPP provider) may determine that the user wishes to compose an e-mail to the service provider associated with the input e-mail address. Further, the e-mail program may determine that the user wants to include a query in the e-mail requesting information about locating/accessing desired services from that service provider and, thus activates the query formatting program (which directs construction of queries for the service provider). In alternative embodiments, the query formatter may be configured for directing construction of queries intended for a plurality of online service providers.

In a present embodiment, the method 100 further includes receiving a query for a desired service of the service provider, wherein the query is contained within an e-mail and is formatted for automated processing by an e-mail server associated with the destination e-mail address 106. As discussed above, the user of the computing device may wish to obtain information about locating/accessing his online ESPP account, in order to view the current status of his stock portfolio. Therefore, the user may compose an e-mail requesting such information to the destination e-mail address associated with the service provider (ex.—the ESPP service provider). In the exemplary embodiment, the e-mail may contain a structured query, as directed by the query formatter, for allowing the service provider (ex.—the ESPP service provider) to better facilitate the user's request (ex.—information about how to locate/access his online stock portfolio). For instance, the user may compose an e-mail having a structured query in the subject line which reads:

### “SEARCH ESPP USER LOGON STOCK PORTFOLIO”

In this manner, the structured query may clearly set forth what the user is requesting from the ESPP service provider (i.e., information about how to locate and access/log onto his account in order to view his online ESPP stock portfolio). As discussed above, in the exemplary embodiment, the query formatter ensures that the e-mail query is constructed and formatted for automated processing by an e-mail server associated with the destination e-mail address (ex.—of the ESPP provider). In a current embodiment, the e-mail query may further include security information, such as a digital signature, encryption information, or the like.

In the exemplary embodiment, the method further includes transmitting the e-mail to the destination e-mail address 108. For example, the e-mail program of the user's computing device may transmit the e-mail (which contains the query), via the Internet, to the e-mail address associated with the ESPP service provider. In the present embodiment, the e-mail query is structured and formatted for automated processing by an e-mail server associated with the destination e-mail address (i.e., e-mail address associated with the service provider). In current embodiments, during processing, the e-mail server associated with the destination e-mail address may parse the e-mail and check its credentials and formatting. In further embodiments, the e-mail server associated with the destination e-mail address may utilize web services to facilitate automated processing of the query. For instance, web services may be software systems designed to support interoperable machine-to-machine communication over a network. Further, software applications written in various programming languages & running on various platforms may use web services to exchange data over computer networks like the Internet. In further embodiments, processing by the e-mail server associated with the destination e-mail address is asynchronous, meaning that processing may operate independently of other processes, thereby freeing a user who has sent the e-mail to the destination e-mail address to do other activities, such as browsing the Internet, or the like, while processing is ongoing.

In the present embodiment, the method 100 further includes receiving a response e-mail from the destination e-mail address, the response e-mail containing at least one Uniform Resource Locator (URL), the at least one URL corresponding to a webpage of the service provider from which the desired service is accessible 110. For example, the user requesting information about accessing/locating his online stock portfolio may receive via the e-mail program on his computing device a response e-mail from his ESPP service provider's e-mail server. The response e-mail may include at least one URL (i.e., web address) corresponding to a webpage of the ESPP service provider from which the user may access his account.

In the exemplary embodiment, the method 100 further includes receiving an input selection corresponding to a URL included in the at least one URL contained in the response e-mail 112. For instance, the user may select a URL which appears to direct the user to a login page of the ESPP service provider's website for accessing his online account information.

In the present embodiment, the method 100 further includes linking to the webpage associated with the input URL 114. For example, in response to receiving the input selection of the URL, the computing device being utilized by the user links the user to the selected webpage via the Internet. For instance, if the selected webpage is a login page, the user may be linked via the Internet to a webpage which prompts the user to provide a private password, or the like for accessing his online ESPP account. Thus, the present invention may provide user access to desired online information/services in a focused manner, which precludes the user having to spend time blindly navigating the service provider's website trying to find the desired information/services. Further, the exemplary embodiments, by providing a structured query via e-mail, allow the user a way to maintain a record of the query. For example, the user may want to access the same information/services at a later time, but may have forgotten the webpage which allowed him to access such information/services. Because, the structured query was sent via e-mail, a record may be maintained of the query by the user's e-mail program (ex.—it may be stored in the e-mail SENT box) and may be accessible to the user at the later time for allowing him to re-access said information/services.

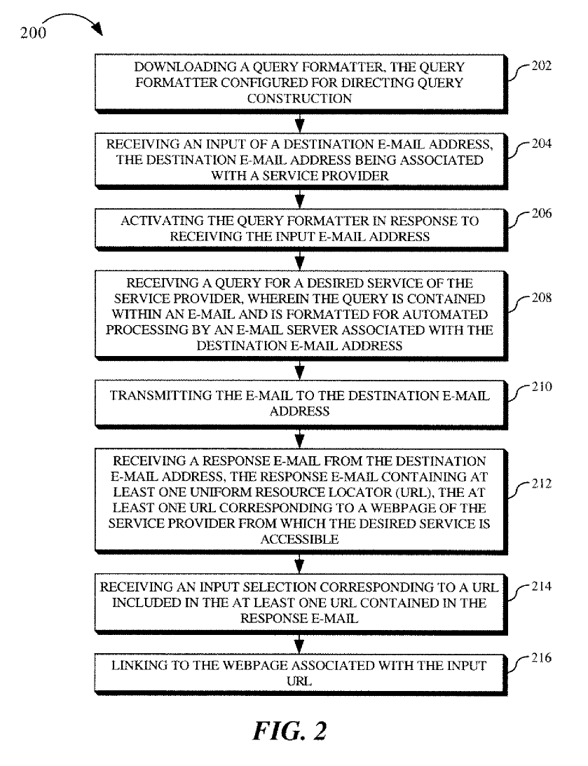

FIG. 2 is a flow chart illustrating a method 200 for providing a structured e-mail query in accordance with an alternative exemplary embodiment of the present invention. The method 200 includes downloading a query formatter, the query formatter configured for directing query construction 202. In the exemplary embodiment, the query formatter may be a program, application, engine, or the like, which may be available online for download to the user's computing device. For example, the query formatter may be available for download from a website associated with a service provider to whom the structured e-mail query is to be directed. The method 200 further includes receiving an input of a destination e-mail address, the destination e-mail address being associated with a service provider 204. The method 200 further includes activating the query formatter in response to receiving the input e-mail address 206. The method 200 further includes receiving a query for a desired service of the service provider, wherein the query is contained within an e-mail and is formatted for automated processing by an e-mail server associated with the destination e-mail address 208. The method 200 further includes transmitting the e-mail to the destination e-mail address 210. The method 200 further includes receiving a response e-mail from the destination e-mail address, the response e-mail containing at least one Uniform Resource Locator (URL), the at least one URL corresponding to a webpage of the service provider from which the desired service is accessible 212. The method 200 further includes receiving an input selection corresponding to a URL included in the at least one URL contained in the response e-mail 214. The method 200 further includes linking to the webpage associated with the input URL 216.

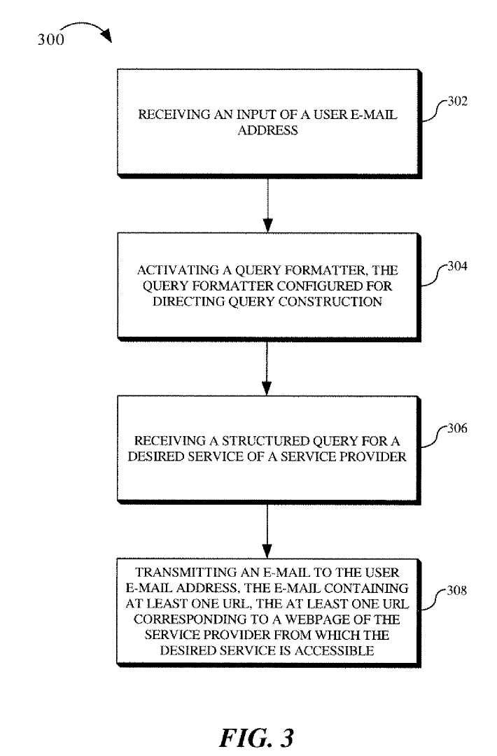

FIG. 3 is a flowchart illustrating a method 300 for providing an e-mail from a service provider, the e-mail being responsive to a structured query in accordance with an alternative exemplary embodiment of the present invention. The method 300 includes receiving an input of a user e-mail address 302. For instance, a user may directly access a website of a service provider and be prompted to enter his e-mail address. The method 300 further includes activating a query formatter, the query formatter configured for directing query construction 304. For example, the query formatter may be implemented on the website of the service provider for directing query construction via the service provider website. The method 300 further includes receiving a structured query for a desired service of the service provider 306. The method 300 further includes transmitting an e-mail to the user e-mail address, the e-mail containing at least one Uniform Resource Locator (URL), the at least one URL corresponding to a webpage of the service provider from which the desired service is accessible 308. In this way, the user may only have to access a home search page of the service provider website and enter his e-mail address and structured query. The user may then receive information responsive to the query via e-mail which will direct him to the information he seeks, without having to spend time navigating the service provider website.

It is contemplated that the invention may take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

It is further contemplated that the medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, microphone, speakers, displays, pointing devices, and the like) may be coupled to the system either directly or through intervening I/O controllers.

Network adapters may also be coupled to the system to enable the data processing system to become couple to other data processing systems or storage devices through intervening private or public networks. Modems, cable modem and Ethernet cards are just a few of the currently available types of network adapters.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages is to be understood by the foregoing description, and it is apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for providing a structured e-mail query, comprising:
receiving an input of a destination e-mail address, the destination e-mail address being associated with a service provider;
activating a query formatter in response to receiving the input e-mail address, the query formatter configured for directing query construction; and,
receiving a query for a desired service of the service provider,
wherein the query is contained within an e-mail and is formatted for automated processing by an e-mail server associated with the destination e-mail address.

2. A method as claimed in claim 1, further comprising:
transmitting the e-mail to the destination e-mail address.

3. A method as claimed in claim 2, further comprising:
receiving a response e-mail from the destination e-mail address, the response e-mail containing at least one Uniform Resource Locator (URL), the at least one URL corresponding to a webpage of the service provider from which the desired service is accessible.

4. A method as claimed in claim 3, further comprising:
receiving an input selection corresponding to a URL included in the at least one URL contained in the response e-mail.

5. A method as claimed in claim 4, further comprising:
linking to the webpage associated with the input URL.

6. A method as claimed in claim 5, wherein the query formatter is downloaded from a website associated with the service provider.

7. A method as claimed in claim 6, wherein the e-mail server associated with the destination e-mail address processes the query utilizing web services.

8. A computer program product, comprising:
a computer useable medium including computer usable program code for performing a method for providing a structured e-mail query including:
computer usable program code for receiving an input of a destination e-mail address, the destination e-mail address being associated with a service provider;
computer usable program code for activating a query formatter in response to receiving the input e-mail address, the query formatter configured for directing query construction; and
computer usable program code for receiving a query for a desired service of the service provider,
wherein the query is contained within an e-mail and is formatted for automated processing by an e-mail server associated with the destination e-mail address.

9. A computer program product as claimed in claim 8, further comprising:
a computer useable medium including computer usable program code for transmitting the e-mail to the destination e-mail address.

10. A computer program product as claimed in claim 9, further comprising:
a computer useable medium including computer usable program code for receiving a response e-mail from the destination e-mail address, the response e-mail containing at least one Uniform Resource Locator (URL), the at least one URL corresponding to a webpage of the service provider from which the desired service is accessible.

11. A computer program product as claimed in claim 10, further comprising:
a computer useable medium including computer usable program code for receiving an input selection corresponding to a URL included in the at least one URL contained in the response e-mail.

12. A computer program product as claimed in claim 11, further comprising:
a computer useable medium including computer usable program code for linking to the webpage associated with the input URL.

13. A computer program product as claimed in claim 12, wherein the query formatter is downloaded from a website associated with the service provider.

14. A computer program product as claimed in claim 13, wherein the e-mail server associated with the destination e-mail address processes the query utilizing web services.

15. A method for providing a structured e-mail query, comprising:
downloading a query formatter, the query formatter configured for directing query construction;
receiving an input of a destination e-mail address, the destination e-mail address being associated with a service provider;
activating the query formatter in response to receiving the input e-mail address; and,
receiving a query for a desired service of the service provider,
wherein the query is contained within an e-mail and is formatted for automated processing by an e-mail server associated with the destination e-mail address.

16. A method as claimed in claim 15, further comprising:
transmitting the e-mail to the destination e-mail address.

17. A method as claimed in claim 16, further comprising:
receiving a response e-mail from the destination e-mail address, the response e-mail containing at least one Uniform Resource Locator (URL), the at least one URL corresponding to a webpage of the service provider from which the desired service is accessible.

18. A method as claimed in claim 17, further comprising:
receiving an input selection corresponding to a URL included in the at least one URL contained in the response e-mail.

19. A method as claimed in claim 18, further comprising:
linking to the webpage associated with the input URL.

20. A method for providing an e-mail from a service provider, the e-mail being responsive to a structured query, comprising:
receiving an input of a user e-mail address;
activating a query formatter, the query formatter configured for directing query construction;
receiving a structured query for a desired service of the service provider; and
transmitting an e-mail to the user e-mail address, the e-mail containing at least one Uniform Resource Locator (URL), the at least one URL corresponding to a webpage of the service provider from which the desired service is accessible.
